(19) United States
(12) Patent Application Publication
(10) Pub. No.: US 2005/0155926 A1
(43) Pub. Date: Jul. 21, 2005

(54) System and method for synthesizing a polymer membrane

(76) Inventors: Kwon Il Kim, Burlington (CA); Mailvaganam Mahendran, Mississauga (CA); Hua Chen, Burlington (CA); Wayne Jerald Henshaw, Burlington (CA)

Correspondence Address: ANDREW ALEXANDER & ASSOCIATES, 3124 KIPP AVENUE, P.O. BOX 2038, LOWER BURRELL, PA, 15068, US

(21) Appl. No.: 11/010,037

(22) Filed: Dec. 11, 2004

Related U.S. Application Data
(63) Continuation-in-part of application No. 10/969,798, filed on Oct. 20, 2004.
(60) Provisional application No. 60/530,919, filed on Dec. 22, 2003.
(60) Provisional application No. 60/512,081, filed on Oct. 20, 2003.
(60) Provisional application No. 60/527,718, filed on Dec. 9, 2003.

(51) Int. Cl. B01D 33/21; C08J 5/00

(52) U.S. Cl. 210/500.36; 264/331.14

(57) ABSTRACT

A method of synthesizing a polymer membrane is described in which a tetrafluoroethylene, hexafluoropropylene and vinylidene fluoride (THV) terpolymer is blended with a solvent containing polychlorotrifluoro ethylene (CTFE). The resultant blend is melted and shaped into a desired form before cooling the blend to thereby induce polymer membrane formation and process for making a membrane using THV in a NIPS process is also disclosed.

This is an application claiming the benefit under 35 USC 119(e) of U.S. Provisional Application Ser. No. 60/530,919, filed Dec. 22, 2003, and a continuation-in-part of U.S. Ser. No. 10/969,798, filed Oct. 20, 2004, which is an application claiming the benefit under 35 USC 119(e) of U.S. Provisional Application Ser. No. 60/512,081, filed Oct. 20, 2003, and No. 60/527,718, filed Dec. 9, 2003. Each of the applications listed above are incorporated herein, in their entirety, by this reference to them.

### FIELD OF THE INVENTION

This invention relates to microporous membranes, and more specifically to a method and system for synthesizing a polymer microporous membrane.

### BACKGROUND OF THE INVENTION

Microporous membranes are widespread and have myriad applications. For example, microporous membranes are used for microfiltration (filtering down to 0.1 pm) and ultrafiltration (filtering down to 0.01 pm) in the pharmaceutical, biomedical and food industries. As filters, microporous membranes find use in water purification, dialysis, membrane distillation and membrane solvent extraction.

Factors to consider when synthesizing a membrane for filtration are the symmetry, pore shape, pore size and strength of the membrane. Aside from appropriately small pore size, microfiltration and ultrafiltration applications demand membrane strength because the membrane has to be able to withstand the pressure required to force liquid therethrough. and other stresses, for example as caused by cleaning methods. As the size of the particles to be separated decreases, strength is particularly important because the pressure and cleaning intensity required to perform the filtration increases.

Microporous membranes have been prepared by a variety of methods, including sintering of ceramic, graphite, metal or crystalline polymer powders; stretching of extruded homogeneous polyolefin or polytetrafluoroethylene films; track etching of homogeneous polycarbonate or polyester films; and phase inversion solution casting of a variety of polymers.

In the process known as “TIPS” (thermally induced phase separation), the polymer is mixed with a solvent and the mixture subsequently heated to melt the blend and to form a homogeneous solution. When the solution is fast quenched or cooled, phase separation occurs in the blend system, leading to the formation of a porous structure.

Another phase inversion method for producing porous polymeric materials is “NIPS,” (non-solvent induced phase separation). In this method, a solution of a polymer and a solvent is prepared. A film of the solution is disposed on a substrate, and an appropriate amount of solvent is removed. The film is then contacted with a fluid which is a non-solvent for the polymer, but which is miscible with the solvent to induce phase inversion in the film.

Diffusion induced phase separation (DIPS) is yet another method that has been used to prepare membranes, especially flat sheet membranes. A polymer solution consisting of at least one polymer and solvent is brought into contact with a coagulation bath. The solvent diffuses outwards into the coagulation bath and the precipitating solution diffuses into a cast film. The exchange of non-solvent and solvent yields a solution that becomes thermodynamically unstable resulting in the separation of the components. A flat sheet is obtained with an asymmetric or symmetric structure.

While these methods have been used previously, the resultant membranes often have a poor permeability, low bubble point and poor mechanical strength. In some previously used techniques, the resultant membrane pore size falls in the microfiltration range and is unsuitable for ultrafiltration applications.

### SUMMARY OF THE INVENTION

The method provided herein uses an appropriate solvent in a thermally induced phase separation (TIPS) process to produce a THV membrane with excellent characteristics. Specifically, the use of polychlorotrifluoro ethylene (CTFE) oligomer as a solvent results in a membrane with characteristics appropriate for both microfiltration and ultrafiltration applications.

Also described herein is a method for synthesizing a THV polymer using dimethyl acetamide (DMAc) as the solvent.

THV polymer, when used as described herein, has several advantages, such as good chemical stability and performance, while allowing for UF and MF applications. It has good resistance to aggressive chemical species (e.g., oxidizing agents) and to conditions of high pH (e.g., caustic solutions).

In particular, a method of synthesizing a THV membrane is described herein. The method includes blending a THV compound with a CTFE solvent. The method further includes melting the resultant blend, together with an optional nucleating agent, and then shaping the blend into a desired form. Subsequently, the blend is cooled, such as by quenching, to thereby induce THV membrane formation.

Also described herein is a method for synthesizing a THV polymer using dimethyl acetamide (DMAc) as the solvent. The method involves forming a THV membrane for UF/MF applications via a NIPS process that includes preparing a THV dope using dimethyl acetamide (DMAc) as the solvent, casting a membrane, and leaching the membrane in water to make a membrane via the NIPS process.

### BRIEF DESCRIPTION OF THE DRAWINGS

For a better understanding of the present invention and to show more clearly how it may be carried into effect, reference will now be made, by way of example, to the accompanying drawing, in which:

FIG. 1 shows a flowchart for synthesizing a polymer membrane, according to the teachings of the present invention.

### DETAILED DESCRIPTION OF THE INVENTION

Described herein is a method for synthesizing a membrane containing THV, a terpolymer formed from the three monomers tetrafluoroethylene (TFE), vinylidene fluoride (VDF) and hexafluoropropylene (HFP). This THV membrane has several advantages. THV is a terpolymer that is manufactured and sold by 3M Canada™ and is readily available. Various grades of the THV polymer containing different ratios of the three monomers are available therefrom. Because TFE is one of the building blocks, this terpolymer has excellent chemical resistance to oxidizing agents (e.g., hypochlorite solution) and alkaline conditions (pH=12-14). Also, because HFP is one of the building blocks, the THV terpolymer has a low melting point (130-150° C., depending on the composition), which makes it suitable for membrane preparation through a TIPS process.

TVH has poor solubility in common solvents. For example, in experiments conducted by us, THV 220 terpolymer did not fully dissolve in NMP to form a homogeneous solution. For example, at 150° C. and with extensive mixing, 22(wt)% THV-78% NMP only lead to a cloudy mixture, rather than a clear, homogeneous solution. The present invention utilizes a solvent that is capable of being used to synthesize the THV membrane. In particular, poly chloro tri fluoro ethylene (CTFE) oligomer is a desirable solvent for the THV terpolymer. Synthesizing the THV membrane using CTFE as a solvent results in a microporous membrane that is useful for both microfiltration and ultrafiltration applications. The solvent can be used to form the THV membrane in a Thermally Induced Phase Separation (TIPS) process.

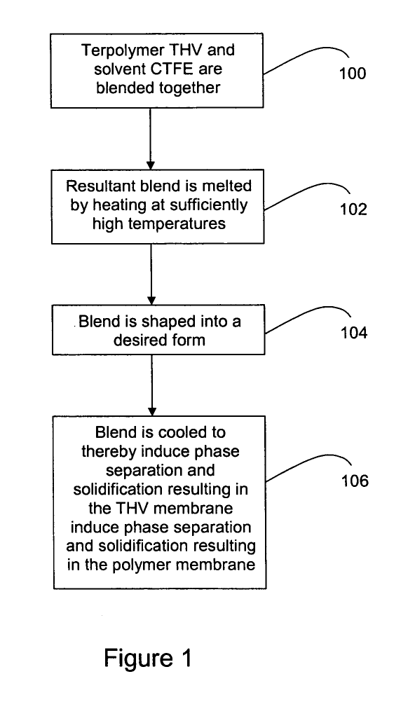

FIG. 1 shows a flowchart for synthesizing a THV membrane. In step 100, the terpolymer THV and the solvent CTFE are blended together. Optionally, a nucleating agent, such as at least one of talc, silica, calcium carbonate and alumina, may be added. If silica is used, a large surface area (greater than 100 m²/g) is advantageous.

In step 102, the resultant blend is melted by heating at sufficiently high temperatures. In step 104, the blend is shaped into a desired form. Subsequently, in step 106, the blend is cooled to thereby induce phase separation and solidification resulting in the THV membrane. The resultant membrane, with a pore size in the range 0.01 to 1 micron, is useful for both microfiltration and ultrafiltration applications.

CTFE is used in step 100. When heated to an appropriate temperature, the THV terpolymer is miscible with CTFE, producing a clear and stable solution.

The concentrations of the components of the blend depend in turn on the desired concentrations during the extrusion, molding, or casting process used to form the resultant membrane. Miscibility of the composition at the extrusion, molding or casting temperature is one factor to be considered in shaping the blend. Miscibility of polymer solutions may be readily determined empirically by methods known in the art. The amount of the diluents used in the composition is advantageously sufficient to itself solubilize the THV terpolymer at the extrusion, molding, or casting temperature; that is, no other solvent other than CTFE is necessary to solubilize the THV terpolymer. The target pore size of the membrane, transport rate through the membrane, and membrane strength are dictated by the ultimate use of the membrane, and it is these factors that determine the appropriate blend composition.

In the melting step 102, the THV terpolymer and the CTFE solvent may be heated and mixed in any convenient manner with conventional mixing equipment, such as a jacket-heated batch mixer. Alternatively, the mixture may be homogenized by extruding the mixture through a twin screw extruder, cooling the extrudate, and grinding or pelletizing the extrudate to a particle size that is readily fed to a single or twin screw extruder. The components of the mixture may also be combined directly in a melt-pot or twin-screw extruder and extruded into membranes in a single step.

The mixture is heated to a temperature that results in a homogeneous mixture possessing a viscosity suitable for extrusion, spinning, molding or casting. The temperature should not be so high as to cause significant degradation of the THV terpolymer. On the other hand, the temperature should not be so low as to render the mixture too viscous to extrude.

The step of shaping 104 can proceed using a number of methods, such as by extruding, molding, casting or spinning. The methods can be divided into two classes, depending on whether the resultant membrane is supported by another material (Class I), or unsupported (Class II).

To produce a Class I (supported) membrane, the polymer blend can be extruded around a hollow braid that contains a synthetic fiber or a glass fiber. In one embodiment, the outer diameter of the tubular braid is smaller than about 3.5 mm. The blend is then quenched to yield the polymer membrane that forms an outer coating on the hollow braid. The polymer membrane remains affixed to the braid during the working life of the membrane, the braid providing support thereto. Thus, a supported hollow fiber results that has extraordinary tensile strength. Further details of the braid, including a method of manufacturing same, are provided in U.S. Pat. No. 6,354,444 B1, the contents of which are incorporated herein by this reference to it.

A system for producing a braided semi-permeable hollow fiber membrane can be used. The polymer solution blend is introduced into a coating nozzle at a flow rate determined by the speed that the tubular braid is advanced through the rounding orifice of the coating nozzle. The flow rate should provide only as much blend as can be supported on the outer portion of the braid. The membrane may be coated on a tubular macroporous support made of synthetic fiber or glass fiber.

In another Class I method, the polymer can be applied to a flat non-woven fabric. Like the braid, this fabric also remains affixed to the membrane for support. A system for producing this type of membrane that is supported by the flat non-woven fabric can be used.

One Class II method involves extruding the blend of polyvinylidene fluoride polymer, solvent and optionally the nucleating agent through a hollow fiber, resulting in a wire-shaped structure. Alternatively, the polymer blend can be applied to a flat surface to produce a sheet-like structure. The polymer sheet is removed from the flat the surface, and is therefore unsupported.

Another Class II method involves spinning a homogeneous blend. The blend should possess a suitable viscosity for spinning at a given temperature, such as a viscosity of about 2×10³ to 1×10⁵ centipoises. The mixture may be spun at room temperature or at elevated temperatures depending upon the viscosity of the solution and the cloud point. The mixture is preferably spun at a temperature of about 25° C. to about 250° C.

In one embodiment, the THV membrane is formed as a hollow fiber using a tube-in-orifice spinnerette. The axial passageway of the spinnerette contains a lumen forming fluid. The outwardly concentric passageway contains a homogeneous mixture of the polymer and the solvent solution to form the membrane. The membrane is formed when the solution exits the spinnerette, optionally passing through an air gap, and enters a quenching fluid bath that contains a quenching fluid. The composition and temperature of the lumen and quenching fluids determine the pore size and frequency of pores on the membrane surfaces.

The lumen fluid is transported to the extrusion head by means of metering pumps. The streams are individually heated and transported along thermally insulated pipes. The lumen fluid and the membrane forming solution are brought to substantially the same temperature in a closely monitored temperature zone where the blend is shaped.

The spinnerette and all the attached lines need to be heated to above the cloud point of the solution. When the mixture is extruded to make a hollow fiber membrane, the spinnerette used includes means for supplying fluid to the core of the extrudate. The lumen forming material is used to prevent the collapse of the hollow fiber as it exits the spinnerette. The lumen forming material may be an inert gas such as nitrogen or a mixture of solvent and non-solvent. The temperature and composition of the lumen fluid can affect the structure and properties of the membrane.

The hollow fiber membrane exits the spinnerette completely formed and there is no need for any further formation treatment except for cooling and removing the solvent from the membrane in a post-extrusion operation.

An appropriate extraction solvent that does not dissolve the terpolymer, but which is miscible with the CTFE solvent, may be used to remove the latter from the finished membrane. When the blend contains a nucleating agent, an additional step may be needed to remove it from the membrane.

The lumen forming fluid may be selected from a wide variety of liquids, such as polyethyleneglycol 400-dimethacrylate (PEG 400), and inert gases such as nitrogen. Other substances may also be used as the lumen forming fluid and the quenching fluid: a non-solvent for the polymer; a weak solvent or high boiling latent solvent for the polymer, or mixtures thereof.

The extrudate exiting the spinnerette enters one or more quench or coagulation zones. The environment of the quench or coagulation zone may be gaseous or liquid or a combination thereof. Within the quench or coagulation zone, the extrudate is subjected to cooling and/or coagulation to cause phase separation and solidification of the membrane. In a preferred embodiment, the membranes are quenched in air. Within the quench zone, the membranes gel and solidify.

Subsequent to or instead of the air quench, the membrane may optionally be quenched or coagulated in a liquid that is substantially a non-solvent for the THV terpolymer.

The residence time in the liquid quench or coagulation zone at the liquid quench temperature should be sufficient to gel and solidify the membranes. As the membrane extruded from the polymer/solvent/optional non-solvent mixture cools, phase separation of the polymer and the solvent and optional non-solvent occurs. Phase separation results in discrete regions of solvent and optional non-solvent being formed in the membrane. These regions, when ultimately leached out, form the pores for the microporous membrane of the invention.

In yet another alternative for the step 104 of shaping, the membrane can be formed by casting the mixture onto a smooth support surface and drawing down the mixture to an appropriate thickness with a suitable tool, such as a doctor blade or casting bar. Alternatively, the mixture may be cast in a continuous process by casting the mixture onto endless belts or rotating drums. The casting surface is such that the finished membrane may thereafter be readily separated from the surface, making this latter method Class II. Alternatively, the mixture may be cast onto a support surface, such as a non-woven web, which may thereafter be dissolved away from the finished membrane.

Several methods for synthesizing a THV membrane consistent with the teachings of the present invention are now described.

One method for synthesizing a THV ultrafiltration or microfiltration membrane is via a TIPS process. The method includes heating and mixing THV with a suitable latent solvent to form a dope, casting a membrane, and quenching the membrane in a suitable liquid bath to form the pores with appropriate pore sizes.

The THV (Dyneon™ 220G) terpolymer is a low-melting-point polymer with good chemical resistance and mechanical strength. One of the difficulties to form a THV membrane comes from the fact that the THV terpolymer does not completely dissolve in most common solvents such as aprotic solvent (e.g., N-methyl pyrrolidinone, or NMP) and common plasticizers such as triacetin, phthalates and trimellitates even above its melting point. By properly choosing the latent solvent and quenching conditions, membranes with high porosity and MF/UF pore sizes are obtained, in accordance with the principles of the present invention.

A second method for synthesizing a THV membrane involves using a latent solvent for dissolving the THV terpolymer to form a homogeneous solution at elevated temperatures. Preferably the latent solvent is a chlorotrifluoro ethylene (CTFE) oligomer. A especially preferred latent solvent is a CTFE oligomer with a boiling point greater than about 150° C., more preferably greater than 165° C. Such CTFE oligomers are available from HaloCarbon. The THV terpolymer has a melting point of about 130° C. and forms a homogeneous solution with CTFE oligomer at about 150-170° C. Heating and mixing can be done in any appropriate equipment.

Generally, polymer solutions for forming membranes via a TIPS process have cloud point temperatures below which the solution would phase separate to give polymer-rich and solvent-rich phases. Cloud point curve of a system defines the selection of mixing and quenching conditions. For a given system, the cloud point depends on the composition of the system.

After the melted THV forms a clear, homogeneous solution with the CTFE oligomer, the dope can be cast into any form (e.g., unsupported hollow fiber, supported hollow fiber, tubular as well as flat sheet membranes) using any suitable methods. The most commonly used casting methods using dies or casting blades are known to those skilled in the art.

A third method for synthesizing a THV membrane provides a quenching fluid for quenching the above-formed dope. It has been found that the quenching fluids and temperatures are a factor in determining the pore size and micro-structure of the membrane formed. It is found in the present invention that the CTFE oligomer, in the temperature range of 0-120° C., is a suitable quenching media for the TIPS process. More preferably the temperature range is 20-70° C. Under those quenching conditions, a porous membrane with a pore size 0.01-1 micron and with a three-dimensional network is formed via the TIPS process.

The CTFE oligomer in the formed membrane can be extracted by common solvents such as iso-propanol alcohol. Further, the extracted CTFE oligomer and the solvents can be recovered and reused.

In a fourth method for synthesizing, the invention provides a method of forming a THV membrane for UF/MF applications via a NIPS process that includes preparing a THV dope using dimethyl acetamide (DMAc) as the solvent, casting a membrane, and leaching the membrane in water to make membranes via NIPS processes.

Unexpectedly, dimethyl acetamide (DMAc) is found to be a good solvent for the THV 220 terpolymer. At about 130° C. and with proper mixing, 22(wt)% THV completely dissolves in (78%) DMAc and forms a clear, homogeneous solution suitable for making a membrane with fine, controlled micro-structures.

According to a fifth method for synthesizing, the invention provides a method of forming a polymeric UF or MF membrane that includes mixing pore forming agent (such as silica) in DMAc, heating and dissolving THV polymer into that above mixture to form a homogeneous solution, casting a membrane, and leaching the pore forming agent from the membrane with leachant (NaOH solution can be used if silica is the pore forming agent).

In a sixth method for synthesizing, an improved structure of a polymeric ultrafiltration or microfiltration membrane is produced. The quenching rate (the time needed to transform the liquid dope into a rigid piece of membrane in the quenching fluid) is fine-tuned by the addition of non-solvents to a membrane dope. Preferably the non-solvent is added in relatively low concentrations and most preferably it is polyethylene glycol (DEG). Most preferably, PEG 200-1000 is used as the non-solvent. However, any non-solvents may be used.

A seventh method of synthesizing a THV polymer provides improving the hydrophilicity of a polymeric ultrafiltration or microfiltration membrane by the addition of surfactants to a membrane dope. Preferably the surfactant is added in relatively low concentrations (0-5 wt. %) and most preferably it is a fluorinated surfactant, such as Zonyl surfactants from DuPont™. Other surfactants may also be used.

### EXAMPLE 1

Seventy-five grams of silica are added into 1080 grams of DMAc in a mixer at room temperature. After sufficient mixing, the mixture appears translucent and homogeneous. Then, the mixer temperature is raised to 135° C. and 345 grams of Dyneon THV 220 is added into the mixture while stirring. The mixing continues for 3 hrs. Then the homogeneous dope is allowed to de-gas for 3 hrs while the dope temperature is lowered to 70° C.

The fiber is spun into a hot water bath with an air gap of about 10 cm. Fiber samples are further leached in water for about 15 hrs followed by leaching in 5% NaOH aqueous solution for 24 hrs. Fiber dimensions and characterization results are listed in the following table.

| Parameters | Values |
|---|---|
| Bore fluid | PEG 400 |
| Die temperature, ° C. | 70 |
| Quench bath | Water, 60° C. |
| OD/ID, mm | 0.75/0.60 |
| Permeability, gfd/psi | 43.9 |
| Bubble point, psi | Samples burst before bubbling. |
| Burst point, psi | 18 psi |

SEM images of the fiber obtained from this example show the membrane has an asymmetric structure. The inner skin and the cross section of the membrane are very porous while a denser layer exists near the outer skin. The pore size is suitable for ultrafiltration.

Having thus described the invention,

1. A method of synthesizing a polymer membrane, the method comprising:
blending a tetrafluoroethylene, hexafluoropropylene and vinylidene fluoride (THV) terpolymer with a solvent containing polychlorotrifluoro ethylene (CTFE);
melting the resultant blend;
shaping the blend into a desired form; and
cooling the blend to thereby induce polymer membrane formation.

2. The method of claim 1 further comprising adding a nucleating agent.

3. The method of claim 1, wherein, in the step of adding, the nucleating agent includes at least one of talc, silica, calcium carbonate and alumina.

4. The method of claim 1, wherein the step of cooling includes inducing phase separation and solidification of the polymer.

5. A method of making a membrane using THV in a NIPS process.
